(19) United States
(12) Patent Application Publication
(10) Pub. No.: US 2022/0169221 A1
(43) Pub. Date: Jun. 2, 2022

(54) BRAKING FORCE CONTROL APPARATUS

(71) Applicant: TOYOTA JIDOSHA KABUSHIKI KAISHA, Toyota-shi Aichi-ken (JP)

(72) Inventors: Yusuke Imura, Mishima-shi Shizuoka-ken (JP); Toshifumi Kawasaki, Toyota-shi Aichi-ken (JP); Kazuki Nemoto, Susono-shi Shizuoka-ken (JP)

(21) Appl. No.: 17/532,380

(22) Filed: Nov. 22, 2021

(30) Foreign Application Priority Data
Nov. 27, 2020 (JP) 2020-196724

(51) Int. Cl. B60T 8/72; B60T 7/22; B60T 8/172

(52) U.S. Cl. CPC B60T 8/72; B60T 2201/022; B60T 8/172; B60T 7/22

(57) ABSTRACT

A braking force control apparatus performs a brake assist control for assisting braking of a vehicle when there is an obstacle ahead of the vehicle and when a driver-deceleration, which is a deceleration corresponding to an operation of a brake pedal by a driver, is less than a necessary-deceleration, which is a deceleration needed to avoid the vehicle colliding with the obstacle. The braking force control apparatus includes: a calculator configured to calculate a deceleration profile in which a deceleration increases with time, as a part of the brake assist control, in order to stop the vehicle at a target position without the vehicle colliding with the obstacle; and an output device configured to output a target-deceleration based on the deceleration profile, as a requested-deceleration, as another part of the brake assist control.

### CROSS-REFERENCE TO RELATED APPLICATIONS

This application is based upon and claims the benefit of priority of the prior Japanese Patent Application No. 2020-196724, filed on Nov. 27, 2020, the entire contents of which are incorporated herein by reference.

### BACKGROUND

### 1. Technical Field

Embodiments of the present disclosure relate to a braking force control apparatus.

### 2. Description of the Related Art

For this type of apparatus, for example, Japanese Patent Application Laid Open No. 2015-136957 (hereinafter Patent Literature 1) proposes that the apparatus performs a braking force assistance (i.e., brake assist) control upon detection of the possibility of a collision of a vehicle, and determines the execution of the braking force assist control when an estimated time to the arrival of the vehicle at the position of an obstacle is less than a first predetermined time and when it is determined that a driver has performed an emergency braking operation. Japanese Patent Application Laid Open No. 2018-203015 (hereinafter Patent Literature 2) is cited as another related technology/technique. Patent Literature 2 discloses a technology/technique for performing a feed-forward control and a feedback control so as to stop the vehicle at a stop position.

In the technology/technique described in Patent Document 1, the braking force assist control may cause a braking force more than necessary (in other words, excessive deceleration) in the vehicle, and the vehicle may be stopped in a state where a distance from the vehicle to the obstacle is relatively long (in other words, in a state where a remaining distance to the obstacle is relatively long).

### SUMMARY

In view of the problem described above, it is therefore an object of embodiments of the present disclosure to provide a braking force control apparatus that is configured to stop a vehicle at an appropriate position while avoiding a collision between the vehicle and the obstacle.

The above object of embodiments of the present disclosure can be achieved by a braking force control apparatus configured to perform a brake assist control for assisting braking of a vehicle when there is an obstacle ahead of the vehicle and when a driver-deceleration, which is a deceleration corresponding to an operation of a brake pedal by a driver of the vehicle, is less than a necessary-deceleration, which is a deceleration needed to avoid the vehicle colliding with the obstacle, the braking force control apparatus including: a calculator configured to calculate a deceleration profile in which a deceleration increases with time, as a part of the brake assist control, in order to stop the vehicle at a target position without the vehicle colliding with the obstacle; and an output device configured to output a target-deceleration based on the deceleration profile, as a required-deceleration, as another part of the brake assist control.

### BRIEF DESCRIPTION OF THE DRAWINGS

FIG. 1 is a block diagram illustrating a configuration of a braking force control apparatus according to an embodiment;

FIG. 2A is a diagram for explaining an example of a method of determining whether or not to permit a brake assist control according to the embodiment;

FIG. 2B is a diagram for explaining an example of a method of determining whether or not to permit a brake assist control according to the embodiment;

FIG. 3A is a conceptual diagram illustrating an example of a change in deceleration in the brake assist control according to the embodiment;

FIG. 3B is a conceptual diagram illustrating another example of a change in deceleration in the brake assist control according to the embodiment; and

FIG. 4 is a flowchart illustrating the operation of the braking force control apparatus according to the embodiment.

### DETAILED DESCRIPTION OF THE EMBODIMENT

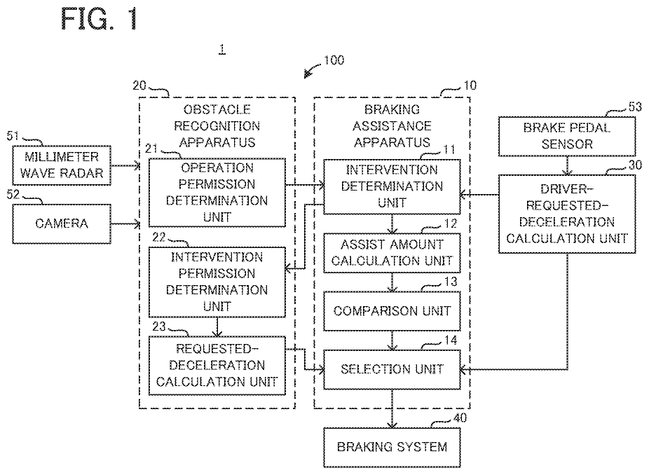

A braking force control apparatus according to an embodiment will be described with reference to FIG. 1 to FIG. 4. In FIG. 1, a braking force control apparatus 100 is mounted on a vehicle 1. The braking force control apparatus 100 performs a brake assist control to assist the braking of the vehicle 1 when there is an obstacle ahead in a travel direction of the vehicle 1 (hereinafter referred to as a “forward obstacle”) when a deceleration corresponding to the operation of a not-illustrated brake pedal by a driver of the vehicle 1 (hereinafter referred to as a “driver-required-deceleration” as occasion demands) is less than a deceleration needed to avoid the vehicle 1 colliding with the forward obstacle (hereinafter referred to as a “collision-avoidance-deceleration” as occasion demands).

The “obstacle” means an obstacle that impedes the travel of the vehicle 1. The “obstacle” may be a stationary object, such as, for example, a parked vehicle, a falling object on a street, a fence, and a road cone, and may be a moving body, such as, for example, another vehicle, a bicycle, and a pedestrian that travel ahead in the travel direction of the vehicle 1.

Such an obstacle may be detected or recognized, for example, from target information obtained from a detection result of a millimeter wave radar 51 mounted on the vehicle 1, image information obtained from a camera 52, or the like. A detailed explanation of a specific method of detecting or recognizing an obstacle will be omitted because various existing aspects are applicable to the method.

The vehicle 1 may be provided not only with the millimeter wave radar 51 and the camera 52 but also with another type of external recognition sensor, such as, for example, a LiDAR (Light Detection and Ranging). Furthermore, the vehicle 1 may be provided with a plurality of millimeter wave radars 51, or may be provided with a plurality of cameras 52. On the other hand, the vehicle 1 may be provided with only one of the millimeter wave radar 51 and the camera 52.

The driver-required-deceleration may be calculated, for example, by a driver-required-deceleration calculation unit 30. The driver-required-deceleration calculation unit 30 may detect or estimate a degree of the operation of the brake pedal by the driver from the output of a brake pedal sensor 53. Then, the driver-required-deceleration calculation unit 30 may calculate the driver-required-deceleration on the basis of the detected or estimated degree of the operation of the brake pedal.

The brake pedal sensor 53 may detect, for example, the pressure of a brake master cylinder (hereinafter referred to as “M/C pressure” as occasion demands) and an M/C pressure gradient. In addition to or in place of the M/C pressure or the M/C pressure gradient, the brake pedal sensor 53 may detect, for example, a stroke amount of the brake pedal, a change amount per unit time of the stroke amount, a stepping force of the brake pedal, a change amount per unit time of the stepping force, or the like.

The driver-required-deceleration calculation unit 30 may increase the driver-required-deceleration, for example, as the M/C pressure detected by the brake pedal sensor 53 increases. The driver-required-deceleration calculation unit 30 may increase the driver-required-deceleration, for example, as the M/C pressure gradient detected by the brake pedal sensor 53 increases. A detailed explanation of a specific method of calculating the driver-required-deceleration will be omitted because the various existing aspects are applicable to the method.

The collision-avoidance-deceleration may be determined, for example, on the basis of a distance from the vehicle 1 to the forward obstacle, a relative speed between the vehicle 1 and the forward obstacle, a current speed of the vehicle 1, and the like. A detailed explanation of a specific method of calculating the collision-avoidance-deceleration will be omitted because various existing aspects are applicable to the method.

The braking force control apparatus 100 includes a braking assistance apparatus 10 and an obstacle recognition apparatus 20 so as to perform the brake assist control. The driver-required-deceleration calculation unit 30 described above may constitute a part of the braking force control apparatus 100, or may not constitute a part of the braking force control apparatus 100 (i.e., may be an apparatus that is independent from the braking force control apparatus 100). Furthermore, the millimeter wave radar 51, the camera 52 and the brake pedal sensor 53 may be provided solely by the braking force control apparatus 100, or the braking force control apparatus 100 may share them with other apparatuses or systems.

The braking assistance apparatus 10 determines whether or not to perform the brake assist control. The braking assistance apparatus 10 determines that the brake assist control is to be performed when the driver-required-deceleration is less than the collision-avoidance-deceleration. On the other hand, the braking assistance apparatus 10 determines that the brake assist control is not to be performed when the driver-required-deceleration is greater than the collision-avoidance-deceleration. When the driver-required-deceleration is equal to the collision-avoidance-deceleration, it may be handled with it included in one of the two cases.

When it is determined by the braking assistance apparatus 10 that the brake assist control is to be performed, the obstacle recognition apparatus 20 calculates a deceleration profile for stopping the vehicle 1 at a target position without the vehicle 1 colliding with the forward obstacle. Here, the “profile” represents a change in a state variable in a time series. In other words, the “profile” represents a time change in the state variable. The “deceleration profile” represents a time change in the deceleration as the state variable. The obstacle recognition apparatus 20 may calculate a deceleration profile in which a deceleration increases with time, as the deceleration profile. In this case, the obstacle recognition apparatus 20 may calculate a deceleration profile in which a deceleration increases linearly with respect to time, as the deceleration profile. Alternatively, the obstacle recognition apparatus 20 may calculate a deceleration profile in which a deceleration increases nonlinearly with respect to time, as the deceleration profile. In this case, the obstacle recognition apparatus 20 may calculate, for example, a deceleration profile in which a deceleration increases quadratically with respect to time.

The target position is a position for stopping the vehicle 1 by the brake assist control. The target position may be set, for example, as a position at which the distance between the vehicle 1 and the forward obstacle does not give fear to or prevents fear to be given to the driver of the vehicle 1 that travels toward the forward obstacle, and in which the vehicle 1 can be stopped at a deceleration that does not give discomfort to or prevents discomfort to be given to the driver of the vehicle 1.

The braking assistance apparatus 10 may output a target-deceleration based on the deceleration profile calculated by the obstacle recognition apparatus 20, as a system-required-deceleration, to a braking system 40 (e.g., a brake ECU (Electronic Control Unit)) that constitutes a part of the braking system 40).

The operation of the braking force control apparatus 100 will be described with reference to FIG. 1 to FIG. 3B. In FIG. 1, the braking assistance apparatus 10 includes an intervention determination unit 11, an assist amount calculation unit 12, a comparison unit 13 and a selection unit 14, as a processing block logically realized therein or a processing circuit physically realized therein. The obstacle recognition apparatus 20 includes an operation permission determination unit 21, an intervention permission determination unit 22, and a required-deceleration calculation unit 23, as a processing block logically realized therein or a processing circuit physically realized therein.

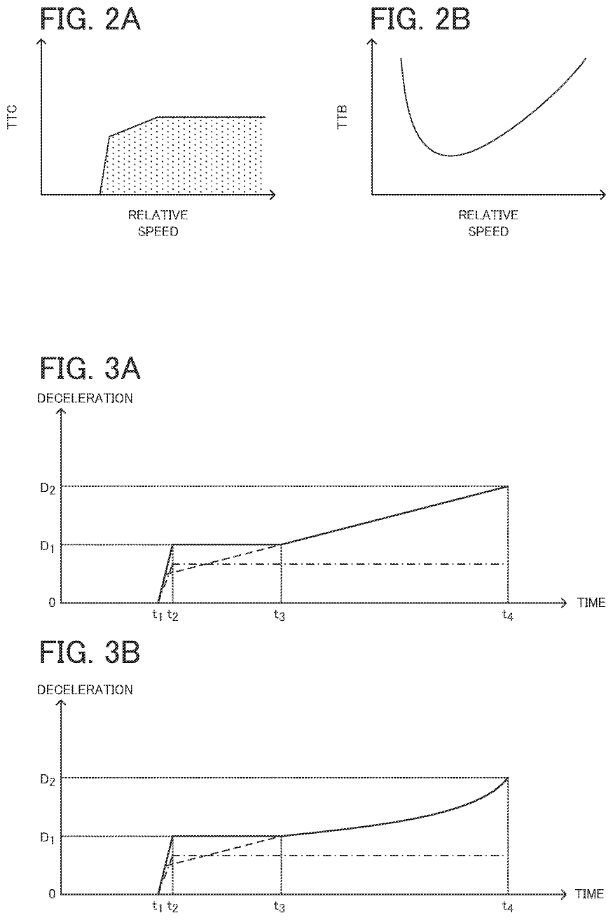

The operation permission determination unit 21 of the obstacle recognition apparatus 20 calculates a TTC (Time To Collision), for example, on the basis of a relative position and a relative speed of the forward obstacle with respect to the vehicle 1. Then, the operation permission determination unit 21 determines whether or not to permit the execution of the brake assist control, from the relative speed of the forward obstacle with respect to the vehicle 1, the calculated TTC, and, for example, a map illustrated in FIG. 2A.

Here, a dotted area of the map illustrated in FIG. 2A is an area corresponding to a state where there is a relatively high possibility that the vehicle 1 collides with the forward obstacle, and the other area of the map illustrated in FIG. 2A is an area corresponding to a state where there is a relatively low or no possibility that the vehicle 1 collides with the forward obstacle.

When a point indicated by a combination of the calculated TTC and the relative speed of the forward obstacle with respect to the vehicle is in the dotted area on the map illustrated in FIG. 2A, the operation permission determination unit 21 permits the execution of the brake assist control. On the other hand, when the above-described point is outside the dotted area on the map in FIG. 2A, the operation permission determination unit 21 does not permit the execution of the brake assist control.

When it is determined that the execution of the brake assist control is permitted, the operation permission determination unit 21 transmits, for example, a permission flag, which indicates a permission of the execution of the brake assist control, to the intervention determination unit 11 of the braking assistance apparatus 10. Due to the transmission of the permission flag to the intervention determination unit 11, the brake assist control enters a Ready state (specifically, a state in which the brake assist control is performed as long as the driver of the vehicle 1 operates the brake pedal).

When the driver-required-deceleration is transmitted from the driver-required-deceleration calculation unit 30 to the intervention determination unit 11 (i.e., when the driver of the vehicle 1 steps on (i.e., operates) the brake pedal) after the permission flag is transmitted to the intervention determination unit 11, the intervention determination unit 11 determines whether or not to perform the brake assist control. Specifically, as described above, the intervention determination unit 11 determines that the brake assist control is to be performed when the driver-required-deceleration is less than the collision-avoidance-deceleration. On the other hand, the intervention determination unit 11 determines that the brake assist control is not to be performed when the driver-required-deceleration is greater than the collision-avoidance-deceleration.

When it is determined that the brake assist control is to be performed, the intervention determination unit 11 transmits, for example, an intervention flag, which indicates the execution of the brake assist control, to the intervention permission determination unit 22 of the obstacle recognition apparatus 20. The intervention permission determination unit 22 that has received the intervention flag calculates a TTB (Time To Brake), for example, on the basis of the relative position and the relative speed of the forward obstacle with respect to the vehicle 1, and the target position for stopping the vehicle 1. Then, the operation permission determination unit 21 determines whether or not to permit the execution of the brake assist control, from the relative speed of the forward obstacle with respect to the vehicle 1, the calculated TTB, and, for example, a map illustrated in FIG. 2B.

Here, an area below a parabola of the map illustrated in FIG. 2B is an area corresponding to a state where there is a relatively high possibility that the vehicle 1 collides with the forward obstacle, and an area above the parabola of the map illustrated in FIG. 2B is an area corresponding to a state where there is a relatively low or no possibility that the vehicle 1 collides with the forward obstacle.

When a point indicated by a combination of the computed TTB and the relative speed of the forward obstacle with respect to the vehicle 1 is in the area below the parabola on the map of FIG. 2B, the intervention permission determination unit 22 permits the execution of the brake assist control. On the other hand, when the above-described point is in the area above the parabola on the map of FIG. 2B, the intervention permission determination unit 22 does not permit the execution of the brake assist control. With this configuration, it is possible to prevent the brake assist control from being excessively performed.

When it is determined that the execution of the brake assist control is permitted, the intervention permission determination unit 22 allows the required-deceleration calculation unit 23 to calculate the deceleration profile described above. The required-deceleration calculation unit 23 transmits the calculated deceleration profile to the braking assistance apparatus 10. Here, the required-deceleration calculation unit 23 may calculate the deceleration profile for an entire period until the vehicle 1 is stopped, or may calculate the deceleration profile for a part of the period. When it is determined by the intervention permission determination unit 22 that the execution of the brake assist control is not permitted, the deceleration profile is not calculated.

Incidentally, it takes a certain amount of time until the deceleration profile is calculated by the required-deceleration calculation unit 23 after the intervention flag is transmitted from the intervention determination unit 11 of the braking assistance apparatus 10 to the intervention permission determination unit 22 of the obstacle recognition apparatus 20. If the system-required-deceleration described above is outputted to the braking system 40 without taking any measures after the deceleration profile is calculated, the generation of a deceleration (in other words, a braking force) caused by the brake assist control is delayed.

Therefore, in the braking force control apparatus 100, when the intervention determination unit 11 determines that the brake assist control is to be performed, the intervention determination unit 11 transmits the intervention flag to the intervention permission determination unit 22, as described above, and allows the assist amount calculation unit 12 to calculate the deceleration. Here, the assist amount calculation unit 12 may calculate an assist-deceleration, for example, by multiplying the driver-required-deceleration by a coefficient that is greater than 1.

The assist amount calculation unit 12 transmits the assist-deceleration to the comparison unit 13. The comparison unit 13 compares the assist-deceleration with a lower-limit-deceleration, which is a lower limit value of a deceleration range associated with the brake assist control (i.e., a range of the deceleration that is settable in the brake assist control). Then, the comparison unit 13 transmits a smaller one of the assist-deceleration and the lower-limit-deceleration to the selection unit 14, as an support-deceleration.

Before the deceleration profile is calculated by the required-deceleration calculation unit 23, the selection unit 14 compares the support-deceleration with the driver-required-deceleration calculated by the driver-required-deceleration calculation unit 30. Then, the selection unit 14 selects a larger one of the support-deceleration and the driver-required-deceleration, and outputs it to the braking system 40. With this configuration, it is possible to prevent that the deceleration (in other words, the braking force) is not assisted (i.e., the assist of the deceleration is delayed) until the deceleration profile is calculated even in a situation in which the brake assist control is performed.

After the deceleration profile is calculated by the required-deceleration calculation unit 23, the selection unit 14 compares the support-deceleration, the driver-required-deceleration, and the target-deceleration based on the deceleration profile. Then, the selection unit 14 selects the largest one of the support-deceleration, the driver-required-deceleration, and the target-deceleration, and outputs it to the braking system 40.

An example of the time change in the deceleration of the vehicle 1 caused by the brake assist control performed by the braking force control apparatus 100 configured as described above will be described with reference to FIG. 3A and FIG. 3B. In FIG. 3A and FIG. 3B, a solid line represents the deceleration caused by the brake assist control, an alternate long and short dash line represents the driver-required-deceleration, and a dashed line represents the collision-avoidance-deceleration (i.e., the deceleration required to avoid the vehicle 1 colliding with the forward obstacle).

It is assumed that at a time t1 in FIG. 3A and FIG. 3B, the driver of the vehicle 1 steps on the brake pedal and the intervention determination unit 11 (refer to FIG. 1) determines that the brake assist control is to be performed. Immediately after the driver steps on the brake pedal, the driver-required-deceleration calculation unit 30 calculates the driver-required-deceleration so that a deceleration gradient is less than or equal to an allowable value, for example, in order to prevent a sudden change in the deceleration. Therefore, in a period from the time t₁ to a time t₂, the assist-deceleration calculated by the assist amount calculation unit 12 is less than the lower-limit-deceleration.

Therefore, the comparison unit 13 transmits the assist-deceleration to the selection unit 14 as the above-described support-deceleration. The selection unit 14 selects the assist-deceleration that is a larger one of the assist-deceleration as the support-deceleration and the driver-required-deceleration, and outputs it to the braking system 40 (note that the deceleration profile is not calculated at this time).

At the time t₂, when the assist-deceleration becomes greater than the lower-limit-deceleration, the comparison unit 13 transmits the lower-limit-deceleration to the selection unit 14 as the support-deceleration. The selection unit 14 selects the lower-limit-deceleration that is a larger one of the lower-limit-deceleration as the support-deceleration and the driver-required-deceleration, and outputs it to the braking system 40. A deceleration D₁ in FIG. 3A and FIG. 3B is a deceleration corresponding to the lower limit deceleration.

It is assumed that the deceleration profile is calculated by the required-deceleration calculation unit 23 after the time t₂ and before a time t₃. In this case, the selection unit 14 selects the largest one of the lower-limit-deceleration as the support-deceleration, the driver-required-deceleration, and the target-deceleration based on the deceleration profile. For example, it is assumed that the target-deceleration becomes greater than the lower-limit-deceleration at the time t₃. The selection unit 14 outputs the lower-limit-deceleration to the braking system 40 from the time t₂ to the time t₃, and outputs the target-deceleration to the braking system 40 after the time t₃.

As a result, in a period from the time t₂ to the time t₃, the lower-limit-deceleration is generated in the vehicle 1 due to the brake assist control, and in a period from the time t₃ to a time t₄, the target-deceleration based on the deceleration profile is generated in the vehicle 1 due to the brake assist control. Therefore, a change in the deceleration in the period from the time t₃ to the time t₄, which is illustrated by the solid line in FIG. 3A and FIG. 3B, corresponds to the time change in the deceleration in the deceleration profile. Here, the deceleration profile may be a deceleration profile in which the deceleration increases linearly with respect to time, as illustrated in FIG. 3A, or may be a deceleration profile in which the deceleration increases nonlinearly with respect to time, as illustrated in FIG. 3B. Incidentally, it is assumed that the vehicle 1 is stopped at the target position at the time t₄. A deceleration D₂ in FIG. 3A and FIG. 3B is a deceleration in the deceleration range associated with the brake assist control.

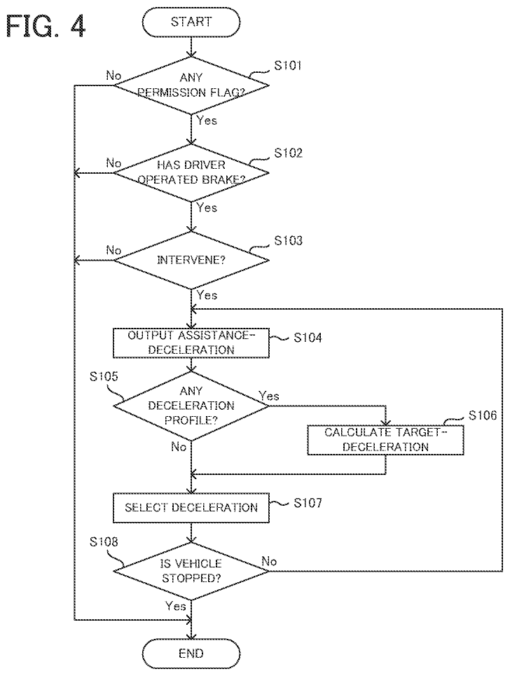

The operation of the braking force control apparatus 100 will be described with reference to a flowchart in FIG. 4. In FIG. 4, firstly, the intervention determination unit 11 of the braking assistance apparatus 10 determines whether or not there is a permission flag (in other words, whether or not the permission flag is received from the operation permission determination unit 21 of the obstacle recognition apparatus 20) (step S101).

In the step S101, when it is determined that there is no permission flag (the step S101: No), the operation illustrated in FIG. 4 is ended. Then, the step S101 is performed again after a lapse of a predetermined time (e.g., several tens of milliseconds to several hundred milliseconds, etc.). That is, the operation illustrated in FIG. 4 is repeatedly performed at a cycle corresponding to the predetermined time.

In the step S101, when it is determined that there is a permission flag (the step S101: Yes), the intervention determination unit 11 determines whether or not the driver of the vehicle 1 has operated the brake pedal (step S102). In the step S102, the intervention determination unit 11 may determine that the driver has operated the brake pedal when it receives the driver-required-deceleration from the driver-required-deceleration calculation unit 30. Furthermore, the intervention determination unit 11 may determine that the driver is not operating the brake pedal when it does not receive the driver-required-deceleration from the driver required-deceleration calculation unit 30 even if a predetermined standby time has elapsed since the start of the step S102. In the step S102, when it is determined that the driver is not operating the brake pedal (the step S102: No), the operation illustrated in FIG. 4 is ended. Then, the step S101 is performed again after a lapse of a predetermined time. In this case, the collision between the vehicle 1 and the forward obstacle may be avoided by an apparatus or a system that is different from the braking force control apparatus 100, such as, for example, a collision damage reducing brake.

In the step S102, when it is determined that the driver has operated the brake pedal (the step S102: Yes), the intervention determination unit 11 compares the driver-required-deceleration with the collision-avoidance-deceleration to determine whether or not to perform the brake assist control (i.e., determines whether or not to intervene in a braking operation by the driver). In the step S103, when it is determined that the brake assist control is not to be performed (the step S103: No), the operation illustrated in FIG. 4 is ended. Then, the step S101 is performed again after a lapse of a predetermined time.

In the step S103, when it is determined that the brake assist control is to be performed (the step S103: Yes), the intervention determination unit 11 transmits the intervention flag to the intervention permission determination unit 22 of the obstacle recognition apparatus 20, and allows the assist amount calculation unit 12 to calculate the assist-deceleration. As a result, the smaller one of the assist-deceleration and the lower-limit-deceleration is outputted from the comparison unit 13 as the support-deceleration (i.e., the support-deceleration is transmitted from the comparison unit 13 to the selection unit 14) (step S104).

Then, the selection unit 14 determines whether or not the deceleration profile is calculated by the required-deceleration calculation unit 23 of the obstacle recognition apparatus 20 (step S105). In the step S105, when it is determined that the deceleration profile is calculated (the step S105: Yes), for example, the selection unit 14 calculates the target-deceleration based on the deceleration profile (step S106). Incidentally, the target-deceleration may be calculated in a processing block or a processing circuit that is different from the selection unit 14.

Then, the selection unit 14 selects the largest one of the support-deceleration (i.e., the smaller one of the assist-deceleration and the lower-limit-deceleration), the driver-required-deceleration, and the target-deceleration, and outputs it to the braking system 40 (step S107).

In the step S105, when it is determined that the deceleration profile is not calculated (the step S105: No), the selection unit 14 selects the larger one of the support-deceleration and the driver-required-deceleration, and outputs it to the braking system 40 (the step S107).

After the step S107, for example, the intervention determination unit 11 determines whether the vehicle 1 is stopped (step S108). In the step S108, when it is determined that the vehicle 1 is not stopped (the step S108: No), the step S104 is performed again. On the other hand, when it is determined that the vehicle 1 is stopped (the step S108: Yes), the operation illustrated in FIG. 4 is ended. Then, the step S101 is performed again after a lapse of a predetermined time.

The deceleration profile may be calculated a plurality of times during the execution of the brake assist control. For example, if the forward obstacle is another vehicle (i.e., a preceding vehicle) that travels ahead in the travel direction of the vehicle 1, the vehicle 1 may not be closer to the preceding vehicle than initially predicted in some driving state of the preceding vehicle. In this case, the required-deceleration calculation unit 23 may calculate a deceleration profile with the deceleration gradient that is gentler than that of the deceleration profile initially calculated. Even in such a case, as long as the driver of the vehicle 1 operates the brake pedal, the required-deceleration calculation unit 23 calculates a deceleration profile in which the deceleration is constant with respect to time (in other words, the deceleration is maintained), or a deceleration profile in which the deceleration increases with time (in other words, the deceleration increases). With this configuration, for example, it is possible to avoid a situation in which the deceleration (in other words, the braking force) of the vehicle 1 decreases even though the driver continues to step on the brake pedal, and it is possible to prevent the driver from feeling discomfort.

Furthermore, if the driver of the vehicle 1 further steps on the brake pedal during the execution of the brake assist control, then, a driver-required-deceleration that is greater than the support-deceleration and the target-deceleration described above may be outputted from the driver-required-deceleration calculation unit 30. In this case, the selection unit 14 of the braking assistance apparatus 10 outputs the driver-required-deceleration to the braking system 40, as the system-required-deceleration. It is possible to prevent the driver from feeling discomfort by giving priority to the driver-required-deceleration. In this case, the execution of the brake assist control may not be released. That is, once the brake assist control is started, the brake assist control may not be released until the vehicle 1 is stopped even though the driver-required-deceleration exceeds the support-deceleration and the target-deceleration.

The braking assistance apparatus 10 may constitute a part of the braking system 40. For example, a not-illustrated brake ECU that constitutes a part of the braking system 40 may function as the braking assistance apparatus 10.

The obstacle recognition apparatus 20 may be formed, for example, integrally with the camera 52. That is, the obstacle recognition apparatus 20 may have, for example, a function as an image processing apparatus for processing a signal outputted from an image pickup element of the camera 52. Alternatively, the obstacle recognition apparatus 20 may be formed, for example, integrally with the millimeter wave radar 51. That is, the obstacle recognition apparatus 20 may have, for example, a function as a signal processing apparatus for processing a signal outputted from a reception unit of the millimeter wave radar 51.

(Technical Effects)

In a brake assist control according to a comparative example, it is only considered to avoid a vehicle colliding with a forward obstacle in many cases. Therefore, in the brake assist control according to the comparative example, a relatively large deceleration (e.g., the maximum value of the deceleration that is settable in the brake assist control, etc.) is often generated in the vehicle immediately after the start. As a result, the vehicle is often stopped in a state where a distance from the vehicle to the forward obstacle is relatively long (in other words, in a state where a remaining distance to the forward obstacle is relatively long).

In contrast to this, the braking force control apparatus 100, the brake assist control is performed such that the vehicle 1 is stopped at the target position while avoiding a collision with the forward obstacle. Specifically, as described above, for example, the deceleration profile in which the deceleration increases with time is calculated such that the deceleration generated in the vehicle 1 is set to be relatively small at the beginning of the brake assist control and that the vehicle 1 is stopped at the target position. Then, the deceleration generated in the vehicle 1 is gradually increased on the basis of the deceleration profile.

By performing such a brake assist control, it is possible to stop the vehicle 1 at an appropriate position while avoiding the collision between the vehicle 1 and the forward obstacle. In addition, when there is another vehicle (i.e., a following vehicle) that travels in the same direction as the travel direction of the vehicle 1 behind the vehicle 1, it is possible to prevent that the following vehicle collides with the vehicle 1 because the vehicle 1 is decelerated or stopped by the brake assist control.

When the deceleration profile in which the deceleration increases linearly with respect to time is calculated as the deceleration profile, it is possible to prevent discomfort caused by the brake assist control from being given to an occupant of the vehicle 1 because the derivative of the deceleration (i.e., jerk) is constant. Furthermore, when the deceleration profile in which the deceleration increases linearly with respect to time is calculated as the deceleration profile, it is possible to reduce a calculation load, as compared with that when the deceleration profile in which the deceleration increases nonlinearly with respect to time is calculated.

Various aspects of embodiments of the present disclosure derived from the embodiment and the modified examples described above will be explained hereinafter.

A braking force control apparatus according to an aspect of embodiments of the present disclosure is a braking force control apparatus configured to perform a brake assist control for assisting braking of a vehicle when there is an obstacle ahead of the vehicle and when a driver-deceleration, which is a deceleration corresponding to an operation of a brake pedal by a driver of the vehicle, is less than a necessary-deceleration, which is a deceleration needed to avoid the vehicle colliding with the obstacle, the braking force control apparatus including: a calculator configured to calculate a deceleration profile in which a deceleration increases with time, as a part of the brake assist control, in order to stop the vehicle at a target position without the vehicle colliding with the obstacle; and an output device configured to output a target-deceleration based on the deceleration profile, as a required-deceleration, as another part of the brake assist control. In the above-described embodiment, the “obstacle recognition apparatus 20” corresponds to an example of the “calculator”, and the “braking assistance apparatus 10” corresponds to an example of the “output device”. Furthermore, in the above-described embodiment, the “driver-requested-deceleration” corresponds to an example of the “driver-deceleration”, the “collision-avoidance-deceleration” corresponds to an example of the “necessary-deceleration”, and the “system-required-deceleration” corresponds to an example of the “required-deceleration”.

In the braking force control apparatus, the deceleration profile may be a deceleration profile in which a deceleration increases linearly with respect to time. Alternatively, in the braking force control apparatus, the deceleration profile may be a deceleration profile in which the deceleration increases nonlinearly with respect to time.

In the braking force control apparatus, the calculator may calculate a deceleration profile so that a deceleration of the vehicle is maintained or increased, when the brake assist control is performed and when the driver steps on the brake pedal.

In the braking force control apparatus, the output device may output the driver-deceleration as the required-deceleration, when the brake assist control is performed and when the driver-deceleration becomes greater than the target-deceleration.

In the braking force control apparatus, the output device may output an support-deceleration, which is a deceleration that is constant with respect to time, as the required-deceleration, as another part of the brake assist control, in at least a part of a period from when the brake pedal operation is started by the driver to when the deceleration profile is calculated. In the above-described embodiment, “the lower-limit-deceleration, as the support-deceleration, transmitted from the comparison unit 13 to the selection unit 14” corresponds to an example of “the support-deceleration”.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A braking force control apparatus configured to perform a brake assist control for assisting braking of a vehicle when there is an obstacle ahead of the vehicle and when a driver-deceleration, which is a deceleration corresponding to an operation of a brake pedal by a driver of the vehicle, is less than a necessary-deceleration, which is a deceleration needed to avoid the vehicle colliding with the obstacle, the braking force control apparatus comprising:
a calculator configured to calculate a deceleration profile, in which a deceleration increases with time, as a part of the brake assist control, in order to stop the vehicle at a target position without the vehicle colliding with the obstacle; and
an output device configured to output a target-deceleration based on the deceleration profile, as a required-deceleration, as another part of the brake assist control.

2. The braking force control apparatus according to claim 1, wherein the deceleration profile is a deceleration profile in which a deceleration increases linearly with respect to time.

3. The braking force control apparatus according to claim 1, wherein the calculator calculates a deceleration profile so that a deceleration of the vehicle is maintained or increased, when the brake assist control is performed and when the driver steps on the brake pedal.

4. The braking force control apparatus according to claim 2, wherein the calculator calculates a deceleration profile so that a deceleration of the vehicle is maintained or increased, when the brake assist control is performed and when the driver steps on the brake pedal.

5. The braking force control apparatus according claim 1, wherein the output device outputs the driver-deceleration as the required-deceleration, when the brake assist control is performed and when the driver-deceleration becomes greater than the target-deceleration.

6. The braking force control apparatus according claim 2, wherein the output device outputs the driver-deceleration as the required-deceleration, when the brake assist control is performed and when the driver-deceleration becomes greater than the target-deceleration.

7. The braking force control apparatus according claim 3, wherein the output device outputs the driver-deceleration as the required-deceleration, when the brake assist control is performed and when the driver-deceleration becomes greater than the target-deceleration.

8. The braking force control apparatus according claim 4, wherein the output device outputs the driver-deceleration as the required-deceleration, when the brake assist control is performed and when the driver-deceleration becomes greater than the target-deceleration.

9. The braking force control apparatus according to claim 1, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

10. The braking force control apparatus according to claim 2, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

11. The braking force control apparatus according to claim 3, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

12. The braking force control apparatus according to claim 4, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

13. The braking force control apparatus according to claim 5, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

14. The braking force control apparatus according to claim 6, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

15. The braking force control apparatus according to claim 7, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.

16. The braking force control apparatus according to claim 8, wherein the output device outputs a support-deceleration, which is a deceleration that is constant with respect to time, as the required-deceleration, as another part of the brake assist control, in at least a part of a period from when the brake pedal operation is started by the driver to when the deceleration profile is calculated.
